(19) United States
(12) Patent Application Publication
(10) Pub. No.: US 2004/0172791 A1
(43) Pub. Date: Sep. 9, 2004

(54) Paper and spring clip, clamp or clasp

(76) Inventor: Douglas Paul Arduini, Fremont, CA (US)

Correspondence Address: DOUGLAS P. ARDUINI, 506 CARTAGENA LANE, SAN RAMON, CA, 94583-1845, US

(21) Appl. No.: 10/719,706

(22) Filed: Nov. 21, 2003

Related U.S. Application Data
(60) Provisional application No. 60/428,894, filed on Nov. 23, 2002.

(51) Int. Cl. B42F 1/02

(52) U.S. Cl. 24/67.9

(57) ABSTRACT

A novel multi-purpose clip or clamp device and improved paper clip which can grip multiple pieces or sheets of material, consisting of a length of resilient material, such as but not limited to spring wire, bent to form a “U” shape lower clamping arm loop with each end bent at slightly different lengths to laterally crisscross each other in the same plane to act as dual spring interconnecting legs and then bent in the same plane to provide dual upper clamping arms. The material is clipped or clamped in between the lower and upper arms that lay flat on the clamped material without distortion, while bending the dual interconnecting spring legs to expand and contract to the variations in material thickness, thereby providing a constant clamping pressure for a wide range of material thickness.

### CROSS-REFERENCE TO RELATED APPLICATIONS

This application claims the benefit of Provisional Patent Application 60/428,894 dated Nov. 23, 2002.

This is a Continuation-in-Part of Provisional Patent Application 60/397,727, filed Jul. 21, 2002, and Regular patent application Ser. No. 10/624,059, Filed Jul. 21, 2003.

### BACKGROUND—FIELD OF INVENTION

This invention relates to spring clips and spring clamps, more specifically an improved multipurpose clip or clamp which can grip multiple papers or other materials with constant clamping pressure and little or no distortion for a wide range of thickness.

### BACKGROUND OF INVENTION

1. Field of the Invention

The present invention relates to a novel multi-purpose clip or clamp device which can grip multiple pieces or sheets of material while providing a constant clamping pressure for a wide range of material thickness while laying flat to the clamped material without distortion, more particularly, to an improved paper clip that provides significant improvements over previously known designs.

2. Description of Prior Art

Many attempts have been made to improve the paper clip and similar spring clamps. Conventional paper clips fail to keep the clamping arms or surfaces parallel with the paper or material over a wide range of thickness, thereby exhibiting distortion outside of the clamped or clipped material thickness. This distortion, buckling, and deforming of the clamping surfaces when adding thickness of the clamped or clipped material, thereby providing interference with each other when stacked, damage the clamped or clipped material surfaces, getting caught on other associated papers and materials, and provide very little gripping force to support the thickness and weight and mass of the clamped or clipped material or paper in all positions or axes. Contact pressure is only on the very edge of the paper due to distortion, thereby easily loosing papers from the stack.

Conventional paper clips are simple and low cost, but have several disadvantages including rotational and longitudinal distortion proportional to the thickness of the material. Conventional clips like, but not limited to, the binder clip, bulldog clip, and banker's clasps are very much thicker than the stack of paper or material thickness to clip and hold. This additional thickness is additive when other stacking clipped papers and material on top of each other in piles, therefore creating a large bulk in one area to make the pile quite unmanageable and wastes space in drawers and boxes. In addition, the binder clip and its folded wire bale catch on other papers to create a nuisance for handling and filing. This invention is a significant improvement over the conventional paper clip with the advantage of an expandable flat profile that is only slightly thicker than the paper or material that is being clipped or clamped, with a simple and low cost design that does not distort a pile when stacking or catch on other papers or materials.

Conventional bulldog clips are also similar to the disadvantages of the conventional binder clip. They are complex and costly to manufacture and are nearly impossible to stack clamped papers or material in a pile without interference and catching on each other. This invention is a significant improvement over the conventional bulldog clip with an expandable flat profile that is only slightly thicker than the paper or material that is being clipped or clamped, with a simple and low cost design that does not distort a pile when stacking or catch on other papers or materials.

U.S. Pat. No. 2,211,034 to Stern relates to folders and retaining contents of folders in place, uses crisscrossing arms, but the material thickness is limited because the spring action is in the clamping arms in the axis parallel to the clamped paper or material.

U.S. Pat. No. 4,523,354 to Tsukamoto uses crisscrossing arms with additional bends after crossing in the center, which are unnecessary. Also, the upper clamping arms extend well beyond the lower clamp loop, thereby the twisting distortion is aggravated.

U.S. Pat. No. 4,597,139 to Lau is a metal wire paper clip structure as an example of prior art with minor changes where the wire of each U-shaped leg loop length ends that extend beyond the interconnector spring loop curved radius to avoid distortion and damage to the paper and improved clasping force claims also include using spring-quality metal and steel wire.

U.S. Pat. No. 4,949,435 to Michelson is a paper clip with a single piece of bent wire having a straight top spine as a torque spring with respect to two bent side legs and bent cross arms that are each perpendicular to the top spine, to minimize angular distortion with thick papers.

U.S. Pat. No. 5,329,672 to Froehlich is a large capacity paper clip uses longer curved wire with more gradual curve shapes with given ratios of wire length to width to height than prior art without distortion and buckling.

U.S. Pat. No. 6,163,934 to Fuster is a multi-purpose paper clip formed of flat cross section material with 2 crossing loops in a figure “8.” This invention has limited clamping pressure on the paper at the crossover point of the figure “8.”

### SUMMARY OF THE INVENTION

The object of the present invention is to provide an improved paper clip and multi-purpose clipping or clamping device that has improved gripping pressure over a wide range of material or sheet thickness, that resists temporary distortion or permanent deformation, and that remains flat to the variable thickness of the clipped or clamped material.

The typical problem with existing paper clips and material clamps is distortion and buckling that occurs, thereby reducing the holding force and clamping effectiveness, but also interfering with and getting caught on other paper stacks or materials. The amount of distortion and buckling is increased by the thickness of the paper or material.

This invention is an improved paper clip and spring-type clip, clamp, clasp, with the unique ability to be thin and to expand over a wide range of displacement of thickness of paper or material and keep it's flat form without distortion while maintaining uniform clamping pressure over a wide area on the clamped material or clipped paper. This invention provides a significant improvement over prior art to minimize distortion, buckling, and deforming, maintains form for reuse, is easy to apply and remove, leaves no damage to clamped material and clipped paper, lays flat and stackable, does not interfere with or get caught on other papers or materials when stacking or filing caused by the gaps under the clip from distortion, eliminates other papers becoming lost when getting caught under the gap from the distorted clip in a stack, eliminates papers coming loose from a clipped stack because of poor contact pressure with clip distortion, and eliminates a safety hazard of a flying paper clip from papers or material being handled or shuffled. This invention is an improved paper or material clip or clamp that has the unique feature of dual crisscrossing spring-like legs of spring-like material connecting to inner and outer clamping arms with various configurations and invention embodiments, thereby allowing the clip or clamp to remain relatively flat and undistorted over a wide range of clamped paper or material thickness.

Two types of distortion or buckling are longitudinal bending and rotational twisting, as shown in FIG. 1A and FIG. 1B with the standard paper clip. The distortion and buckling of the paper clip and material clamp is mitigated with the present invention. Crisscrossing spring legs provide improved and balanced clamping force on the clamping arms with variations of paper or material thickness. The longer the distance between crossing spring legs, the less twisting distortion effect occur on the clamping arms.

This invention in similar form and methods can find various uses and applications as an improved clip or clamp, including but not limited to, clip boards, bulletin boards, magnetic clips and clamps, etc. This invention may be expanded for spring improvements in applications for parallel suspension expansion springs and shear spring expansion without torsion or twisting. Other similar uses of these spring improvements are in applications for parallel suspension expansion springs and shear spring expansion without torsion or twisting.

The object of the present invention is attained by a multi-purpose clip or clamp device and improved paper clip which can grip multiple pieces or sheets of material, consisting of a length of resilient material, such as but not limited to spring wire, bent to form a “U” shape lower clamping arm with each end bent with at a slightly different length to laterally crisscross each other in the same plane to act as dual spring interconnecting legs and then bent in the same plane to provide dual upper clamping arms. The material is clipped or clamped in between the lower and upper arms while bending the dual interconnecting spring legs to expand and contract to the variations in material thickness, thereby providing a constant clamping pressure for a wide range of material thickness.

For a better understanding of the invention, reference may be made to the following description of the drawings and embodiment.

### BRIEF DESCRIPTION OF THE DRAWINGS

The above and further features of the advantages of the present invention are further discussed below with reference to the accompanying drawings, in which:

FIG. 1A is a plan view of standard paper clip of prior art, and FIG. 1B showing an end view of the clamping distortion problem;

FIG. 2A is a plan view of a reference to the previous provisional application 60/397,727 of the improved paper clip with a continuous wire form, and FIG. 2B showing an end view with no clamping distortion;

FIG. 3A is a plan view of a first embodiment of the improved paper clip according to the present invention, with a discontinuous wire form with a termination gap in the upper clamping arm loop, and FIG. 3B is an end view showing no clamping distortion;

FIG. 4A is a plan view of a discontinuous wire form with a termination gap in the lower clamping arm loop, and FIG. 4B is an end view showing no clamping distortion;

FIG. 5A is a plan view of a reference to the previous provisional application 60/397,727 of the improved paper clip as a continuous wire form, and FIG. 5B is an end view showing no clamping distortion;

FIG. 6A is a plan view of a second embodiment of the improved paper clip according to the present invention, with a discontinuous wire form with a termination gap in the upper clamping arm loop, and FIG. 6B is an end view showing no clamping distortion;

FIG. 7A is a plan view with a discontinuous wire form with a termination gap in the lower clamping arm loop, and FIG. 7B is an end view showing no clamping distortion;

FIG. 8A is a plan view with a discontinuous wire form with a termination gap in one of the dual crisscrossing spring connecting legs, and FIG. 8B is an end view showing clamping distortion;

FIG. 9A is a plan view as a reference to the previous provisional application 60/397,727 with a continuous wire form, and FIG. 9B is an end view showing no clamping distortion;

FIG. 10A is a plan view with a discontinuous wire form according to the present invention, with a termination gap in the upper clamping arm loop, and FIG. 10B is an end view showing no clamping distortion;

FIG. 11A is a plan view with a discontinuous wire form a termination gap in the lower clamping arm loop, and FIG. 11B is an end view showing no clamping distortion;

FIG. 12A is a plan view of a reference to the previous provisional application 60/397,727 with a continuous wire form with dual crisscrossing spring connecting legs with rectangular upper and lower clamping arms of equal length but narrower inner clamping arm, and FIG. 12B is an end view showing no clamping distortion;

FIG. 13A is a plan view of a reference to the previous provisional application 60/397,727 with a continuous wire form, and FIG. 13B is an end view showing clamping distortion;

FIG. 14A is a plan view of a third embodiment of the improved paper clip according to the present invention, with a discontinuous wire form with a termination at each end of the upper clamping arm, and FIG. 14B is an end view showing no clamping distortion;

FIG. 15A is a plan view with a discontinuous wire form with a termination at each end of the lower clamping arm, and FIG. 15B is an end view showing no clamping distortion;

FIG. 16A is a plan view with a discontinuous wire form with a termination at each end of the lower clamping arm, and FIG. 16B is an end view showing no clamping distortion;

FIG. 17A is a plan view with a discontinuous wire form with a termination at each end of the outer clamping, and FIG. 17B is an end view showing no clamping distortion;

FIG. 18A is a plan view with a discontinuous wire form with a termination at each end of the inner clamping arm, and FIG. 18B is an end view showing no clamping distortion;

FIG. 19A is a plan view with a discontinuous wire form with a termination at each end of the inner clamping arm, and FIG. 19B is an end view showing no clamping distortion;

FIG. 20A is a plan view of a forth embodiment of the improved paper clip according to the present invention, with a discontinuous wire form with a termination at each end of the outer clamping arm with small loops at the termination ends, and FIG. 20B is an end view showing no clamping distortion;

FIG. 21A is a plan view with a discontinuous wire form with a termination at each end of the inner clamping arm with small loops at the termination ends, and FIG. 21B is an end view showing no clamping distortion;

FIG. 22A is a plan view with a discontinuous wire form with a termination at each end of the inner clamping arm with small loops at the termination, and FIG. 22B is an end view showing no clamping distortion; and

FIG. 23A is a plan view of a fifth embodiment of the improved paper clip according to the present invention, with a discontinuous wire form with a termination at each end of the outer clamping arm with terminating ends that are shaped with rounded or hemispherical tips, and FIG. 23B is an end view showing no clamping distortion.

### DESCRIPTION OF THE PREFERRED EMBODIMENTS

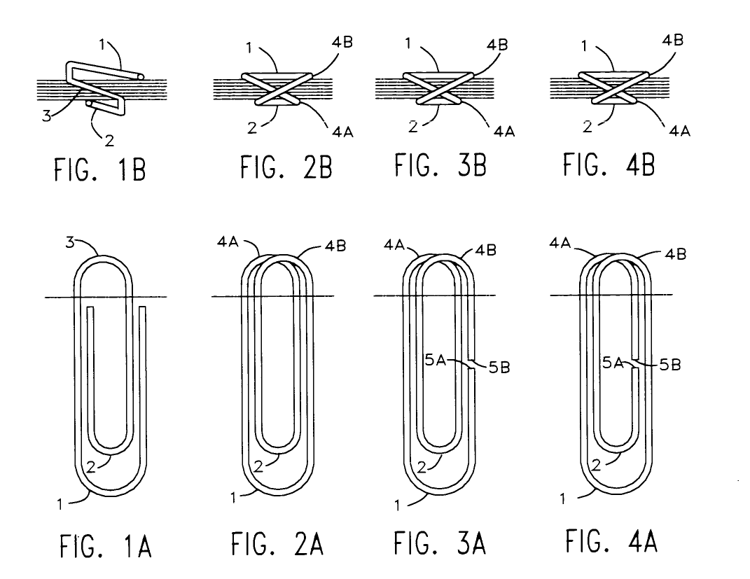

The conventional standard paper clip prior art is shown in FIG. 1A with the length of spring wire formed with a outer or upper clamping arm loop 1 then formed to the interconnecting spring crossing leg 3 then formed to the inner or lower clamping arm loop 2. The typical problems with this prior art design are illustrated in FIG. 1B, showing the lateral and radial displacement result of bending and twisting distortion proportional to the material thickness.

FIG. 2A is an improved paper clip example as referenced to the previous provisional application 60/397,727 to show a major improvement, shows an example not shown that application to show the logical difference in design improvement from prior art shown in FIG. 1A. This improvement of prior art is in accordance with that invention, where the length of spring wire is a continuous strand of spring material formed with oval dual crisscrossing interconnecting spring legs 4A and 4B then formed with an oval lower or inner clamping arm loop 2 and an oval upper or outer clamping arm loop 1. The crisscrossing interconnecting spring legs 4A and 4B expand with spring force to the thickness of the clamped or clipped material without distortion as shown in FIG. 2B with equal and opposite twisting and bending forces that are cancelled in the connecting lower clamping arm loop 2 and the upper clamping arm loop 1. The cancellation of these forces mitigates the twisting and bending distortion of the clamping arms of the standard paper clip as shown in FIG. 1B, as shown in FIG. 2B with flat clamping or clipping arms above and below the clamped or clipped material without distortion.

An improvement to the previous provisional application 60/397,727 as referenced in FIG. 2A and FIG. 2B is shown in FIG. 3A as the first embodiment of the present invention. This improvement incorporates a single strand of spring material that is discontinuous, thereby is simplified in the method of fabrication from a continuous strand. This improvement in accordance with the present invention, is formed with a length of spring material with oval dual crisscrossing interconnecting spring legs 4A and 4B then formed with an oval lower or inner clamping arm loop 1 and an oval upper or outer clamping arm loop 2 that has the discontinuous strand ends 5A and 5B terminating with a small gap. The crisscrossing interconnecting spring legs 4A and 4B expand with spring force to the thickness of the clamped or clipped material with the upper and lower clamping arm loops 2 and 1 remaining flat without distortion as shown in FIG. 3B compared to the distortion shown in FIG. 1B, where the twisting and bending forces of the interconnecting crisscrossing spring legs 4A and 4B are equal and opposite and cancelled at one end with the connecting lower clamping arm loop 1 and the remaining forces distributed to the upper clamping arm loop 2. The cancellation of these forces in the lower connecting clamping arm 1 plus the forces that are split between two crisscrossing interconnecting spring legs 4A and 4B mitigates most of the twisting and bending distortion of the clamping arms 1 and 2 of the standard paper clip as shown in FIG. 1B.

FIG. 4A is a variation of FIG. 3A with the discontinuous strand ends 5A and 5B terminating with a small gap in the lower or inner clamping arm loop 2, with FIG. 4B showing the benefits of the design with the clamping or clipping arms 2 and 1 to remain flat above and below the clamped or clipped material without distortion.

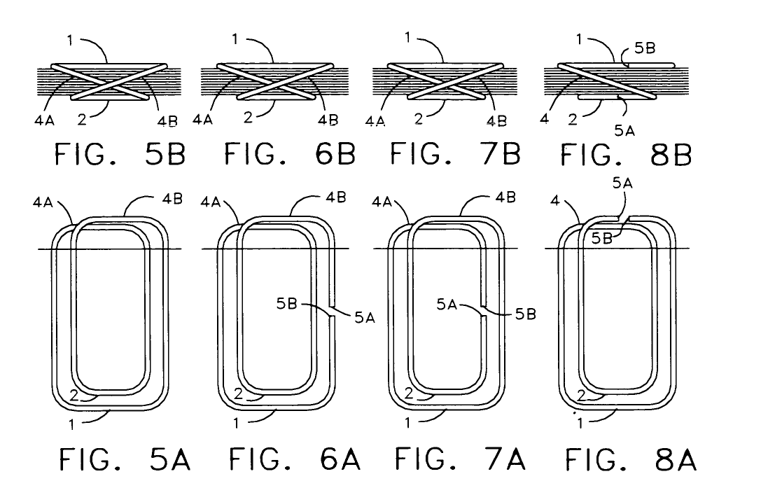

FIG. 5A and FIG. 5B are referenced to the previous provisional application 60/397,727 to show a major improvement of the standard paper clip. This improvement of prior art is in accordance with that invention, where the length of spring wire is a continuous strand of spring material formed with rectangular dual crisscrossing interconnecting spring legs 4A and 4B then formed with a rectangular lower or inner clamping arm loop 2 and a rectangular upper or outer clamping arm loop 1.

An improvement to the previous provisional application 60/397,727 as referenced in FIG. 5A and FIG. 5B is shown in FIG. 6A as the second embodiment of the present invention. This improvement incorporates a single strand of spring material that is discontinuous, thereby is simplified in the method of fabrication from a continuous strand. This improvement in accordance with the present invention, is formed with a length of spring material with rectangular dual crisscrossing interconnecting spring legs 4A and 4B then formed with a rectangular lower or inner clamping arm loop 2 and a rectangular upper or outer clamping arm loop 1 that has the discontinuous strand ends 5A and 5B terminating with a small gap. The crisscrossing interconnecting spring legs 4A and 4B expand with spring force to the thickness of the clamped or clipped material with the upper and lower clamping arms 1 and 2 remaining flat without distortion as shown in FIG. 6B compared to the distortion shown in FIG. 1B, where the twisting and bending forces of the interconnecting crisscrossing spring legs 4A and 4B are equal and opposite and cancelled at one end with the connecting lower clamping arm loop 2 and the remaining forces distributed to the upper clamping arm loop 1. The cancellation of these forces in the lower connecting clamping arm loop 2 plus the forces that are split between two crisscrossing interconnecting spring legs 4A and 4B mitigates most of the twisting and bending distortion of the clamping arm loops of the standard paper clip as shown in FIG. 1B.

FIG. 7A is a variation of FIG. 6A with the discontinuous strand ends 5A and 5B terminating with a small gap in the lower or inner clamping arm loop 2, with FIG. 7B showing the benefits of the design with the clamping or clipping arms 1 and 2 to remain flat above and below the clamped or clipped material without distortion.

FIG. 8A is a variation of FIG. 6A with the discontinuous strand ends terminating with a small gap in one of the dual crisscrossing interconnecting spring legs 4, with FIG. 7B showing the benefits of the design with the clamping or clipping arms 2 and 1 to remain flat above and below the clamped or clipped material without distortion.

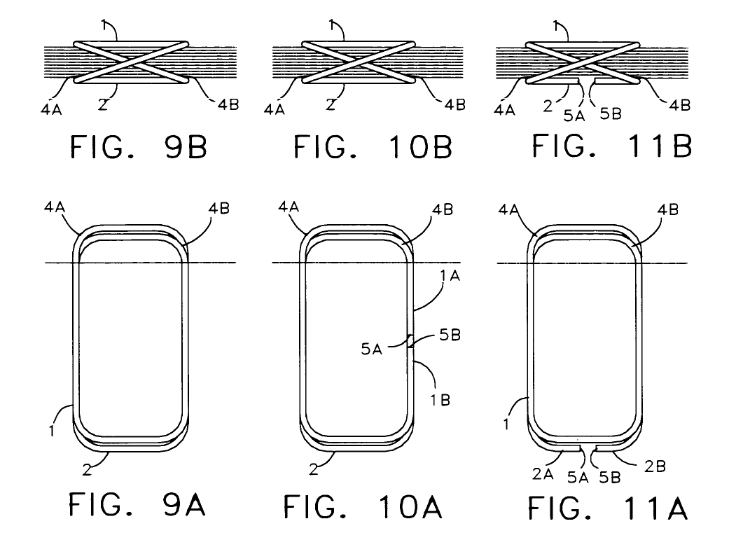

FIG. 9A and FIG. 9B are referenced to the previous provisional application 60/397,727 to show a major improvement of the standard paper clip. This improvement of prior art is in accordance with that invention, where the length of spring wire is a continuous strand of spring material formed with rectangular dual crisscrossing interconnecting spring legs 4A and 4B then formed with a rectangular lower clamping arm loop 2 and a rectangular upper clamping arm loop 1 of equal width and different lengths.

Improvement to the previous provisional application 60/397,727 as referenced in FIG. 9A and FIG. 9B, are shown in FIG. 10A and FIG. 11A as examples of the second embodiment of the present invention. This improvement incorporates a single strand of spring material that is discontinuous, thereby is simplified in the method of fabrication from a continuous strand. This improvement in accordance with the present invention, is formed with a length of spring material with rectangular dual crisscrossing interconnecting spring legs 4A and 4B then formed with a rectangular lower clamping arm loop 2 and a rectangular upper clamping arm loop 1 that has the discontinuous strand ends 5A and 5B terminating with a small gap. The crisscrossing interconnecting spring legs 4A and 4B expand with spring force to the thickness of the clamped or clipped material with the upper and lower clamping arm loops 1 and 2 remaining flat without distortion as shown in FIG. 10B and FIG. 11B compared to the distortion shown in FIG. 2B, where the twisting and bending forces of the interconnecting crisscrossing spring legs 4A and 4B are equal and opposite and cancelled at one end with the connecting lower clamping arm loop 2 and the remaining forces distributed to the upper clamping arm loop 1. The cancellation of these forces in the lower connecting clamping arm loop 2 plus the forces that are split between two crisscrossing interconnecting spring legs 4A and 4B mitigates most of the twisting and bending distortion of the clamping arm loops of the standard paper clip as shown in FIG. 1B.

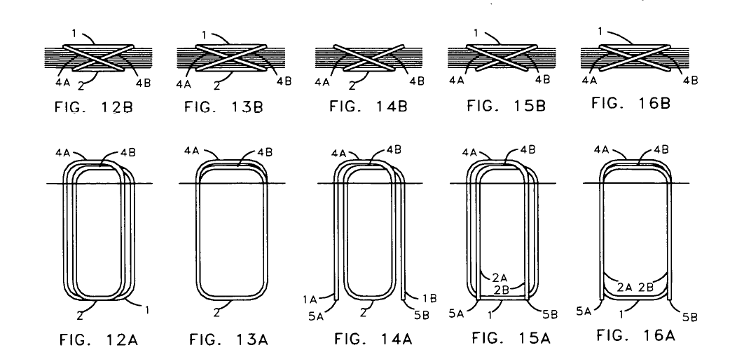

FIG. 12A, FIG. 12B, FIG. 13A, FIG. 13B are variations referenced to the previous provisional application 60/397,727 to show a major improvement of the standard paper clip. This improvement of prior art is in accordance with that invention, where the length of spring wire is a continuous strand of spring material formed with rectangular dual crisscrossing interconnecting spring legs 4A and 4B then formed with a rectangular lower clamping arm loop 2 and a rectangular upper clamping arm loop 1 of various widths and equal lengths.

FIG. 14A is an improvement to the previous provisional application 60/397,727 as referenced in FIG. 12A as a third embodiment of the improved paper clip according to the present invention, with a discontinuous wire form with dual crisscrossing interconnecting spring legs 4A and 4B and a termination 5A and 5B at each end of the two upper clamping arms 1A and 1B and that are wider and equal in length to the lower clamping arm loop 2, with FIG. 14B showing the clamping arms laying flat and with no distortion around the stack of clipped paper or clamped material.

FIG. 15A is a variation of FIG. 14A with a discontinuous wire form with dual crisscrossing interconnecting spring legs 4A and 4B and a termination 5A and 5B at each end of the two lower clamping arms 2A and 2B and that are narrower and of equal length to the upper clamping arm loop 1, with FIG. 15B showing the clamping arms laying flat and with no distortion around the stack of clipped paper or clamped material.

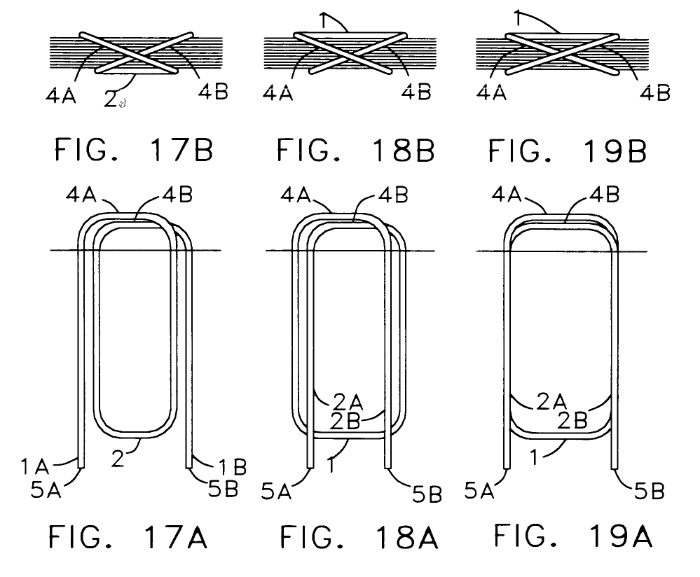

FIG. 16A is a variation of FIG. 14A with a discontinuous wire form with dual crisscrossing interconnecting spring legs 4A and 4B and a termination 5A and 5B at each end of the two lower clamping arms 2A and 2B and that are equal in width and equal in length to the upper clamping arm loop 1, with FIG. 16B showing the clamping arms laying flat and with no distortion around the stack of clipped paper or clamped material.

FIG. 17A is a variation of FIG. 14A with a discontinuous wire form with dual crisscrossing interconnecting spring legs 4A and 4B and a termination 5A and 5B at each end of the two upper clamping arms 1A and 1B and that are wider and longer than the lower clamping arm loop 2, with FIG. 17B showing the clamping arms laying flat and with no distortion around the stack of clipped paper or clamped material.

FIG. 18A is a variation of FIG. 14A with a discontinuous wire form with dual crisscrossing interconnecting spring legs 4A and 4B and a termination 5A and 5B at each end of the two lower clamping arms 2A and 2B and that are narrower and longer than the upper clamping arm loop 1, with FIG. 18B showing the clamping arms laying flat and with no distortion around the stack of clipped paper or clamped material.

FIG. 19A is a variation of FIG. 14A with a discontinuous wire form with dual crisscrossing interconnecting spring legs 4A and 4B and a termination 5A and 5B at each end of the two lower clamping arms 2A and 2B and that are the same width and longer than the upper clamping arm loop 1, with FIG. 19B showing the clamping arms laying flat and with no distortion around the stack of clipped paper or clamped material.

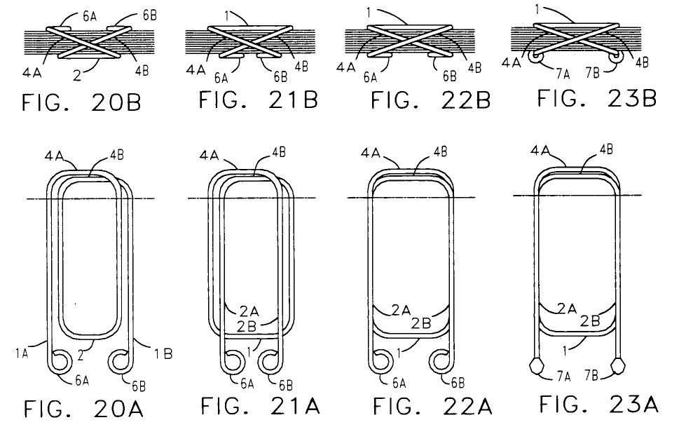

FIG. 20A is a variation of FIG. 14A of a forth embodiment of the improved paper clip according to the present invention, with a discontinuous wire form with dual crisscrossing interconnecting spring legs 4A and 4B and a termination 5A and 5B in the form of a small loop 6A and 6B at each end of the two upper clamping arms 1A and 1B and that are wider and longer than the lower clamping arm loop 2, with FIG. 20B showing the clamping arms laying flat and with no distortion around the stack of clipped paper or clamped material. The small loop 6A and 6B at the end of the clamping arms 1A and 1B is for easier installation and removal of clipped paper or clamped material and protect from gouging or cutting or damaging of the paper or material with the wire cut end. The loops are turned inside versus outside to the area of the clip or clamp to minimize exaggerating and lateral distortion to the loop because of a smaller dimension from the center of the clip or clamp.

FIG. 21A is a variation of FIG. 20A with a discontinuous wire form with dual crisscrossing interconnecting spring legs 4A and 4B and a termination in the form of a small loop 6A and 6B at each end of the two lower clamping arms 2A and 2B and that are narrower and longer than the upper clamping arm loop 1, with FIG. 15B showing the clamping arms laying flat and with no distortion around the stack of clipped paper or clamped material.

FIG. 22A is a variation of FIG. 20A with a discontinuous wire form with dual crisscrossing interconnecting spring legs 4A and 4B and a termination in the form of a small loop 6A and 6B at each end of the two lower clamping arms 2A and 2B and that are the same width and longer than the upper clamping arm loop 1, with FIG. 15B showing the clamping arms laying flat and with no distortion around the stack of clipped paper or clamped material.

FIG. 23A is a variation of FIG. 22A with a discontinuous wire form with dual crisscrossing interconnecting spring legs 4A and 4B and a termination at each end of the two lower clamping arms 2A and 2B and that are the same width and longer than the upper clamping arm loop 1, where the terminated ends 7A and 7B are shaped in the form of rounded or hemispherical or peened tips to prevent scraping or cutting or damage and for easier installation and removal of the paper or other clamped or clipped material, with FIG. 23B showing the clamping arms laying flat and with no distortion around the stack of clipped paper or clamped material

The improved clip or clamp according to the present invention, can be made with any spring type material, such as but not limited to wire, metal, plastic, composite, etc, and of any shape, such as but not limited to round, oval, square, and rectangular.

The improved clip or clamp according to the present invention is designed to mitigate the bending and twisting forces that result in lateral and lateral distortion without the use of a continuous connecting loop. The design can be improved where the amount of distortion can be lowered by increasing the width of the crisscrossing spring legs and by decreasing the length of the clamping arms.

The improved clip or clamp according to the present invention in similar form and methods can find various uses and applications as an improved clip or clamp, including but not limited to, clip boards, bulletin boards, magnetic clips and clamps, etc. Other applications and variations of use of these spring improvements are in applications for parallel suspension expansion springs and shear spring expansion without torsion or twisting.

I claim:

1. A length of spring wire formed into a long “U” shape rectangle loop in the middle of the length as the inner clamping arm, then form each end of the length to criss-cross each other as dual connecting legs in the parallel plane of the first loop forming a box shape in the middle of the length, then form each terminating end into dual outer clamping arms along the axis in parallel and outside the width of the long sides of the inner clamping arm loop, such that the length is the same as the length of the inner clamping arm loop. Thus paper is clamped or clipped with continuous spring pressure between the inner clamping arm loop and the dual outer clamping arms created by the dual crisscrossing connecting legs expanding in the axis perpendicular to the axis of the clamping arms to the thickness of the paper stack.

2. A clamp or clip in accordance with claim 1 wherein the spring wire is some other spring material and/or shape.

3. A clamp or clip in accordance with claim 1 wherein the dual outer clamping arms are inside the width of the long sides of the inner clamping arm loop.

4. A clamp or clip in accordance with claim 1 wherein the dual outer clamping arms are at the same width of the long sides of the inner clamping arm.

5. A clamp or clip in accordance with claim 1 wherein the inner clamping arm “U” shape is oval versus rectangular.

6. A clamp or clip in accordance with claim 1 wherein the dual outer claming arms are longer than the length of the inner claming arm.

7. A clamp or clip in accordance with claim 1 wherein the dual outer claming arms are shorter than the length of the inner claming arm.

8. A clamp or clip in accordance with claim 1 wherein the dual outer claming arms are not parallel with the inner loop, but form toward the center of the inner loop to terminate near each other as outer clamping arms.

9. A clamp or clip in accordance with claim 1 wherein any other material is clamped or clipped other than paper.

10. A clamp or clip in accordance with claim 1 wherein the dual outer claming arms length terminating ends are shaped into loops or rolled-end termination tips to prevent scraping of the paper or other clamped or clipped material.

11. A clamp or clip in accordance with claim 1 wherein the dual outer claming arm length terminating ends are shaped with rounded or peened or hemispherical tips to prevent scraping of the paper or other clamped or clipped material.

12. A clamp or clip in accordance with claim 1 wherein the terminating ends are extended and shaped in bends toward each other in the same plane or axis as the inner loop clamping arm, thereby forming an outer loop clamping arm similar to the inner loop clamping arm with a gap where the two terminations meet.

13. A clamp or clip in accordance with claim 1 where one inner or outer clamping arm loop is part of a base or backing plate to act as a clip board or book binder or notebook binder or notepad and for various claming applications.

14. A clamp or clip in accordance with claim 12 wherein the gap where the two terminations meet may be anywhere in the inner or outer loop clamping arm's length or width, or meet in one of the crisscrossing legs.

15. A clamp or clip in accordance with claim 12 wherein the inner or outer loops may be of different length and/or width of each other.

16. A clamp or clip in accordance with claim 12 wherein the inner or outer loops are oval instead of rectangular and of different widths to allow one to move inside the other as inner and outer loop clamping arms with the paper or other material clamped or clipped in between.

17. A clamp or clip in accordance with claim 12 where one inner or outer clamping arm is part of a base or backing plate to act as a clip board or book binder or notebook binder or notepad and for various claming applications.

18. A length of spring wire formed into dual crisscrossing spring-type legs that expand by the thickness of the paper or material being clamped or clipped and are connected to a lower clamping arm loop and also connected to dual upper clamping arms, thereby providing continuous clamping pressure and mitigating bending and twisting distortion of the clamping arms.

19. A clamp or clip in accordance with claim 18 wherein the spring wire is some other spring material and/or shape.

20. A clamp or clip in accordance with claim 18 where the lower or upper clamping arm or arms is part of a base or backing plate to act as a clip board or book binder or notebook binder or notepad and for various claming applications.
